(19) United States
(12) Patent Application Publication
(10) Pub. No.: US 2007/0203852 A1
(43) Pub. Date: Aug. 30, 2007

(54) Identity information including reputation information

(75) Inventors: Kim Cameron, Bellevue, WA (US); Arun K. Nanda, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/361,857

(22) Filed: Feb. 24, 2006

(51) Int. Cl. G06Q 99/00; H04L 9/00

(52) U.S. Cl. 705/75; 705/65

(57) ABSTRACT

A system for providing reputation information includes a relying party programmed to receive a security token including a claim with reputation information associated with a party, and the relying party is further programmed to utilize the reputation information when deciding whether to transact with the party. A method of providing reputation information includes receiving a request for information from a party, requiring the party to provide reputation information, receiving the reputation information in a claim of a security token, and using the reputation information to decide whether to transact with the party. Another method of providing reputation information includes requesting reputation information associated with a online service from a claims authority, receiving the reputation information in a claim of a security token, and using the reputation information to decide whether to transact with the online service.

### BACKGROUND

Commerce is gaining an ever-increasing presence in the online arena. Many consumers are now interacting with web sites to purchase goods and services, rather than conducting face-to-face transactions in brick and mortar stores. As commerce moves online, consumers may know less about the individuals and businesses that own the web sites that consumers are visiting to purchase goods and services. The reputations of these individuals and businesses can become important to consumers who want to trust the web sites with which they contemplate transacting.

Various disparate services provide reputation information about parties that consumers can access. For example, the Better Business Bureau (“BBB”) provides information about the reputation of various businesses operating in a particular geographic area. In a different context, credit scores provided by the credit rating agencies are another form of reputation information about entities. In another example, eBay users can rate other eBay users after completion of transactions, with the resulting comments being used to create a feedback score, thereby creating a reputation for each eBay user. eBay buyers and sellers can use these reputations to make decisions regarding whether or not to transact with specific eBay users based on the user's reputation.

Services such as the BBB and credit rating agencies provide reputation information that parties can trust the accuracy of with some level of certainty. However, the reputation information offered by these types of organizations is not always easily obtained. For example, to obtain information about a business from the BBB, it is necessary for an individual to contact the BBB and specifically reference the business to obtain the reputation information. Further, such organizations do not always have information about every party. For example, the BBB only includes information about businesses that are members of the BBB organization.

Services such as the feedback mechanisms provided by eBay can cover a broader spectrum of individuals and transactions, such as the thousands of interactions between eBay users. However, the reputation information on eBay may not be as trustworthy as that of, for example, the BBB, since not all users may provide feedback and users may be able to manipulate the feedback. Further, the reputation information is limited, once again, to only eBay users.

Beyond the limitations of these types of services is the inherent ambiguity associated with online transactions. For example, it may be difficult for a consumer to identify who actually operates a particular web site. In such cases, it is difficult for the consumer to even attempt to seek reputation information about the web site, since the consumer cannot easily determine with whom the consumer is contemplating transacting.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect relates to a system for providing reputation information, the system including a relying party programmed to receive a security token including a claim with reputation information associated with a party, and the relying party being further programmed to utilize the reputation information when deciding whether to transact with the party.

Another aspect relates to a method of providing reputation information, the method including: receiving a request for information from a party; requiring the party to provide reputation information; receiving the reputation information in a claim of a security token; and using the reputation information to decide whether to transact with the party.

Yet another aspect relates to method of providing reputation information, the method including: requesting reputation information associated with an online service from a claims authority; receiving the reputation information in a claim of a security token; and using the reputation information to decide whether to transact with the online service.

### DESCRIPTION OF THE DRAWINGS

Reference will now be made to the accompanying drawings, which are not necessarily drawn to scale, and wherein:

FIG. 1 illustrates an example computing environment in which an embodiment of a relying party is programmed to receive reputation information about a principal from a claims authority;

FIG. 2 illustrates the principal, relying party, and claims authority from FIG. 1;

FIG. 3 illustrates an example security token including a computational token and a display token;

FIG. 4 illustrates an example method for a principal to use reputation information as an identity claim;

FIG. 5 illustrates an example method for a claims authority to generate a security token including reputation information;

FIG. 6 illustrates an example method for a relying party to utilize reputation information from an identity claim;

FIG. 7 illustrates another example computing environment in which an example embodiment of a computer system is programmed to receive reputation information from a claims authority;

FIG. 8 illustrates an example method for a user to utilize reputation information about a third party web site from a claims authority;

FIG. 9 illustrates an example graphical user interface of a computer system of FIG. 7 including a display of reputation information; and

FIG. 10 illustrates another example graphical user interface of a computer system of FIG. 7 including a display of reputation information.

### DETAILED DESCRIPTION

Example embodiments will now be described more fully hereinafter with reference to the accompanying drawings. These embodiments are provided so that this disclosure will be thorough and complete. Like numbers refer to like elements throughout.

Example embodiments of the present invention disclosed herein relate generally to creating and storing reputation information for online entities for use in a digital identity environment. In a typical scenario, a client system (also referred to as the principal) communicates with a server system (also referred to as a relying party) over a network. Digital “identities” can be exchanged between these systems to authenticate information transferred between the systems. Moreover, in accordance with aspects of embodiments of the present invention, reputation information may also be exchanged between the principal and the relying party. The reputation information can be provided to the principal by another, independent system, such as a claims authority system. In order to facilitate the exchange of reputation information, in example embodiments the reputation information is transferred within a security token or otherwise trustworthy portion of data, whether coming from the relying party or the claims authority.

Reputation information is information about a party's perceived quality or character as measured by one or more individuals or organizations. Examples of reputation information include, without limitation, feedback (e.g., ratings) by one or more individuals who have previously transacted with the party, a party's credit score as reported by a credit agency, and/or a rating by an organization that is established to provide ratings of a party's goods/services or to aggregate reputation information from multiple other sources. Further examples of reputation include business ratings from the BBB or Dunn & Bradstreet, and service ratings from the AAA. Other forms of reputation information are possible.

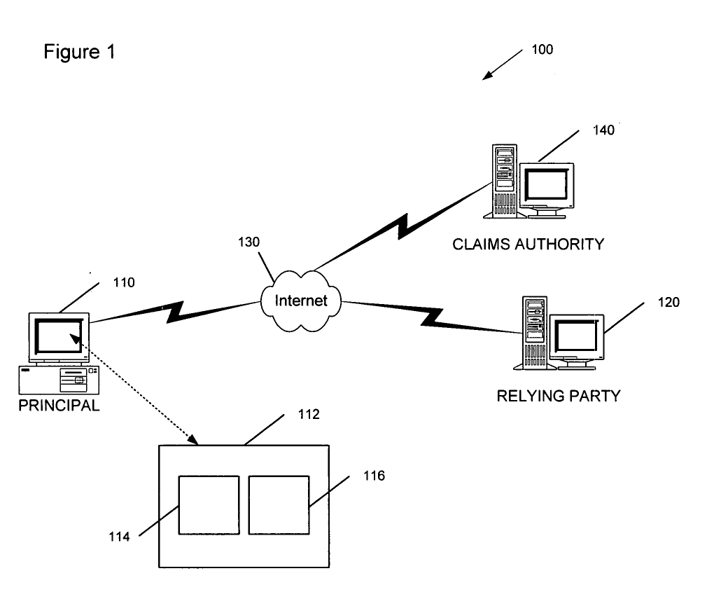

Referring now to FIG. 1, an example digital identity system 100 is shown including a principal 110, a relying party 120, and a claims authority 140. In the example shown, principal 110 can be an individual, a company, an organization, a computer or other device, a service, or any other type of entity. Relying party 120 can be an online service having goods, services, or other information that principal 110 desires to access and/or obtain. Principal 110, relying party 120, and claims authority 140 can communicate with one another over Internet 130.

In example embodiments, principal 110 can be an individual that controls a personal computer including at least one processor and memory. Computer system 110 includes one or more of volatile and non-volatile computer storage media, as well as removable and non-removable media implemented in any method or technology for storage of information such as computer readable instructions, data structures, program modules, or other data. Computer system 110 includes an operating system, such as the WINDOWS operating system from Microsoft Corporation, and one or more programs stored on computer readable media. Computer system 110 also includes one or more input and output communications devices that allow the user to communicate with computer system 110, as well as allow computer system 110 to communicate with other devices, such as the Internet 130 and relying party 120. One example output device shown in FIG. 1 is a display 112.

In the example shown, principal 110 can access a web site associated with relying party 120 using a program such as a browser 114. One example of a browser is the Internet Explorer browser offered by Microsoft Corporation. In one embodiment, browser 114 communicates with relying party 120 using one or more known protocols, such as the hypertext transport protocol (“HTTP”) protocol. Other protocols can be used.

In example embodiments, principal 110 can request goods, services, or other information from relying party 120, and relying party 120 can require information about principal 110 before or in conjunction with providing the requested goods, services, or information. The information required by relying party 120 includes reputation information about principal 110.

In the example shown, claims authority 140 includes one or more entities that can provide one or more claims or assertions about principal 110. A claim is a statement made about a principal relating to the principal's identity or information about the principal such as, for example, name, address, social security number, age, etc. In the examples described herein, a claim can include reputation information about the principal.

In example embodiments, claims authority 140 collects feedback or ratings from other individuals or organizations to generate the reputation information. In other embodiments, claims authority 140 develops the reputation information by, for example, tracking information about the principal. In yet other embodiments, claims authority 140 aggregates reputation information from one or more third parties (e.g., BBB, AAA, etc.). If reputation information is aggregated from multiple sources, the reputation information can be standardized to a specified scale so that reputation information from two or more sources can be compared and a standardized reputation can be calculated.

In one example, claims authority 140 includes a security token service that can issue a signed security token. For example, as described further below, claims authority 140 can provide claims to principal 110 and/or the relying party 120 in the form of a signed security token. One or more of the claims can include reputation information. In example embodiments, claims authority 140 is in a trusted relationship with relying party 120, so that relying party 120 trusts the claims in the signed security token from claims authority 140.

In example embodiments disclosed herein, system 100 is implemented as an InfoCard system provided in the WINFX application programming interface developed by Microsoft Corporation of Redmond, Wash. The InfoCard system allows principals to manage multiple digital identities from various claims authorities. The InfoCard system utilizes a web services platform such as the Windows Communication Foundation in the WINFX application programming interface. In addition, the InfoCard system is built using the Web Services Security Specifications propagated at least in part by Microsoft Corporation of Redmond, Wash. These specifications include a message security model WS-Security, an endpoint policy WS-SecurityPolicy, a metadata protocol WS-MetadataExchange, and a trust model WS-Trust. Example embodiments described herein refer to the Web Services Security Specifications described above. In alternative embodiments, one or more different specifications can be used to facilitate communications between the various components of system 100.

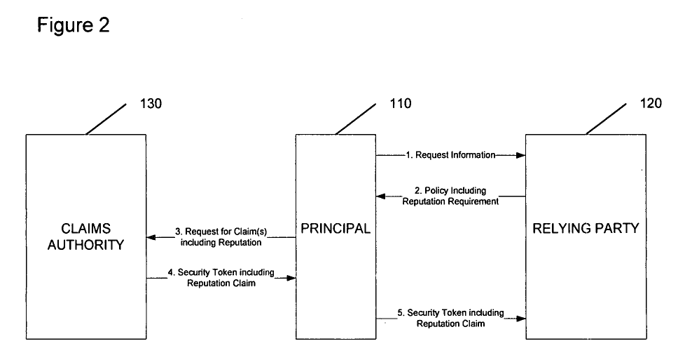

Referring now to FIG. 2, example principal 110, relying party 120, and claims authority 130 are again shown. In the embodiment shown, principal 110 sends a request to relying party 120 for goods, services, or other information. For example, in one embodiment, principal 110 sends a request to relying party 120 for access to information from relying party 120 that principal 110 desires. The request sent by principal 110 can also include a request for a security policy (see below) of relying party 120 using, for example, the mechanisms provided in WS-MetadataExchange.

In response to the request, relying party 120 sends principal 110 requirements for relying party 120 to authenticate the identity or other information about principal 110. The requirements of relying party 120 for authentication are referred to herein as a security policy. The security policy defines the set of claims that the principal 110 must provide to relying party 120 for relying party 120 to authenticate principal 110. In one example, relying party 120 specifies its security policy using WS-SecurityPolicy, although other protocols can be used. In the example shown, the security policy of relying party 120 includes a requirement for a claim associated with the reputation of principal 110.

Once principal 110 receives the security policy from relying party 120, principal 110 communicates with one or more claims authorities to gather the claims required by the policy. In the example shown, principal 110 communicates the requirements of the security policy to claims authority 140. For example, principal 110 can request one or more security tokens from claims authority 140 using the issuance mechanism described in WS-Trust.

Claims authority 140 can provide one or more of the claims required in accordance with the policy from relying party 120. For example, claims authority 140 is programmed to generate one or more claims including reputation information associated with principal 110. In example embodiments, claims authority 140 generates one or more signed security tokens 150 that include the one or more claims with reputation information, as described below.

The security token 150, which includes one or more claims regarding reputation, can then be forwarded by claims authority 140 to principal 110. In example embodiments, claims authority 140 forwards the security token 150 to principal 110 using the response mechanisms described in WS-Trust.

Once principal 110 receives security token 150, principal 110 can forward token 150 to relying party 120 to satisfy all or a part of the security policy of relying party 120. In one example, principal 110 can forward security token 150 to relying party 120 by binding security token 150 to an to application message using the security binding mechanisms described in WS-Security.

Once relying party 120 receives security token 150, relying party 120 can cryptographically verify the origin of signed security token 150. Relying party 120 can utilize the reputation claims in security token 150 to satisfy the security policy of relying party 120. For example, relying party 120 can examine the reputation claims in security token 150 to determine whether or not to trust or otherwise continue transacting with principal 110.

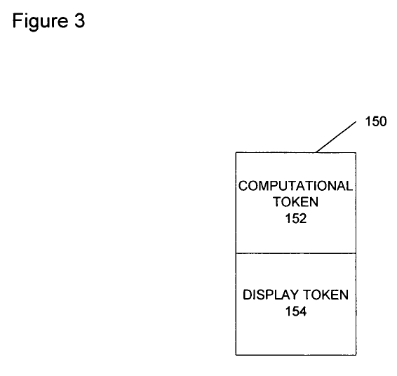

Referring now to FIG. 3, an example security token 150 is shown. In the embodiment shown, security token 150 includes a computational token 152 and a display token 154. Computational token 152 includes the claims provided by claims authority 140 in an encrypted format. In example embodiments, claims authority 140 generates computational token 152 in an encrypted format that can be understood (i.e., decrypted) by relying party 120, as described below.

Claims authority 140 also generates display token 154. Generally, display token 154 includes at least a summary of the claims that are included in computational token 152 of security token 150, including a summary of the reputation claims. For example, in some embodiments, display token 154 includes a list of all of the claims included in computational token 152.

Display token 154 can be generated in a format that can be reviewed by principal 110 using, for example, display 112. In some examples, display token 154 is generated in a plain text format or a Hypertext Markup Language (“HTML”) format. One example embodiment of a display token 154 included as part of a security token response is shown below. In the example, the display token includes information about a claim regarding reputation (i.e., reputation=“medium”).

<ic:RequestedDisplayToken>

<ic:DisplayToken xml:lang=“en-us”>

<ic:DisplayClaim
URI=“http://.../ws/2005/05/identity/claims/reputation”>

<ic:DisplayTag>Reputation</ic:DisplayTag>
<ic:DisplayValue>Medium</ic:DisplayValue>

</ic:DisplayClaim>

<ic:DisplayToken>

</ic:RequestedDisplayToken>

The following is a general description of the elements shown above in the display token:
/ic:RequestedDisplayToken/ic:DisplayToken—the returned display token;
/ic:RequestedDisplayToken/ic:DisplayToken/@xml:lang—this attribute indicates a language identifier, using the language codes specified in RFC 3066, in which the display token content is localized;
/ic:RequestedDisplayToken/ic:DisplayToken/ic:DisplayClaim—this element indicates an individual claim returned in the security token;
/ic:RequestedDisplayToken/ic:DisplayToken/ic:DisplayClaim/@URI—this attribute provides the unique identifier (URI) of the individual claim returned in the security token;
/ic:RequestedDisplayToken/ic:DisplayToken/ic:DisplayClaim/ic:DisplayTag—this optional element provides a common or friendly name for the claim returned in the security token;
/ic:RequestedDisplayToken/ic:DisplayToken/ic:DisplayClaim/ic:Description—this optional element provides a description of the semantics for the claim returned in the security token;
/ic:RequestedDisplayToken/ic:DisplayToken/ic:DisplayClaim/ic:DisplayValue—this optional element provides one or more displayable values for the claim returned in the security token; and
/ic:RequestedDisplayToken/ic:DisplayToken/ic:DisplayTokenText (not shown)—this optional element provides an alternative textual representation of the entire token as a whole when the token content is not suitable for display as individual claims.

In some embodiments, security token 150 including computational token 152 is issued in accordance with the Security Assertion Markup Language (“SAML”) standard promulgated by the Organization for the Advancement of Structured Information Standards (“OASIS”). For example, security token 150 can be issued in accordance with SAML 1.1 or SAML 2.0 standards. Other standards can also be used such as, for example and without limitation, an X.509 certificate, an XrML token, or a Kerberos ticket.

In addition, security token 150 can be cryptographically signed or endorsed by claims authority 140 using a known algorithm. In one embodiment, a 2048-bit asymmetric RSA key is used. In other embodiments, other encryption algorithms can be used such as, for example, a base 64 encoded symmetric encryption key. In one embodiment, a symmetric key is used by default. In this manner, in the example shown, a party such as relying party 120 can cryptographically verify that security token 150 originated from claims authority 140.

In example embodiments, computational token 152 is cryptographically bound to display token 154 using one or more known algorithms such as, for example and without limitation, using a digital signature over the entire response message from claims authority 140 containing both the computational token 152 and the display token 154.

Principal 110 can review the contents of display token 154 before forwarding security token 150 to relying party 120. For example, the contents of display token 154 can be displayed in browser 114 and/or in a separate graphical user interface 116 on display 112, as shown in FIG. 1. In some embodiments, principal 110 can decide whether or not to forward security token 150 to relying party 120 based on the review of the contents of display token 154.

Additional details regarding security tokens including display tokens can be found in U.S. patent application Ser. No. 11/312,920 filed on Dec. 19, 2005, the entirety of which is hereby incorporated by reference.

In alternative embodiments, security token 150 from claims authority 140 need not include a display token. For example, in other embodiments, security token 150 only includes computational token 152 that is utilized by relying party 120. Security token 150 can be forwarded to relying party 120 through principal 110, or can be forwarded directly to relying party 120 by claims authority 140.

For example, in one alternative embodiment, relying party 120 can request and receive reputation information about principal 110 directly from claims authority 140. This configuration allows relying party 120 to obtain reputation information that is not filtered by principal 110.

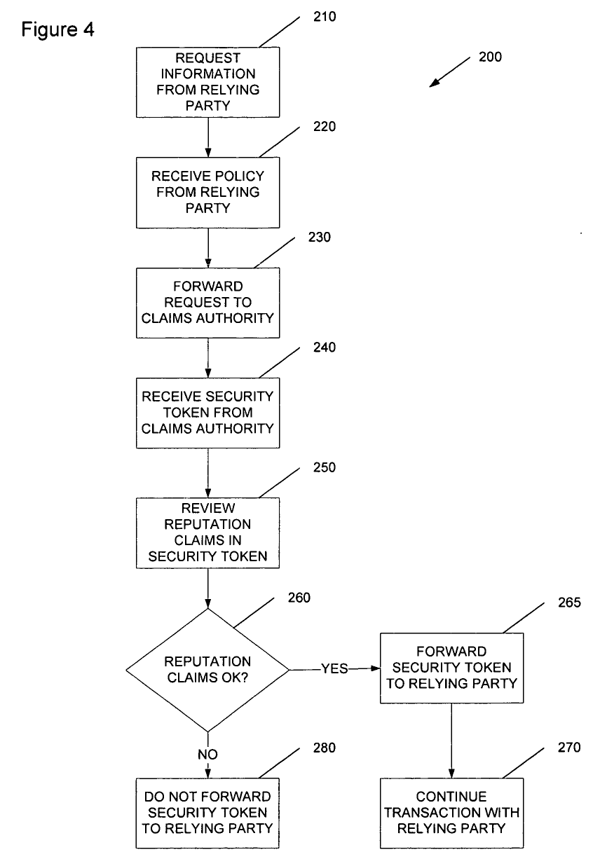

Referring now to FIG. 4, an example method 200 for a principal to utilize a security token including reputation information is shown. At operation 210, the principal requests information from a relying party. For example, in one embodiment, the principal is an individual, and the relying party is a banking institution. The principal uses a computer to access the web site of the banking institution to request approval for a home mortgage.

Next, at operation 220, the bank forwards the bank's security policy to the individual's computer. The policy includes a requirement that the individual have a credit score of a given value or higher to qualify for the mortgage. Control is then passed to operation 230, and the individual sends a request to a credit reporting agency for a security token with one or more claims associated with the individual's credit score. Next, at operation 240, the individual receives a security token with a claim including the individual's credit score. At operation 250, the individual reviews the credit score as indicated in the display token of the security token.

Next, at operation 260, the individual decides whether or not to forward the security token including the credit score to the bank. If the individual decides not to forward the token, control is passed to operation 280, and the token is not forwarded to the bank. Alternatively, if the individual decides at operation 260 to forward the token to the bank, control is passed to operation 265, and the security token is forwarded to the bank. Next, assuming that the credit score meets the criteria required by the bank, control is passed to operation 270 and the individual receives approval for the requested mortgage.

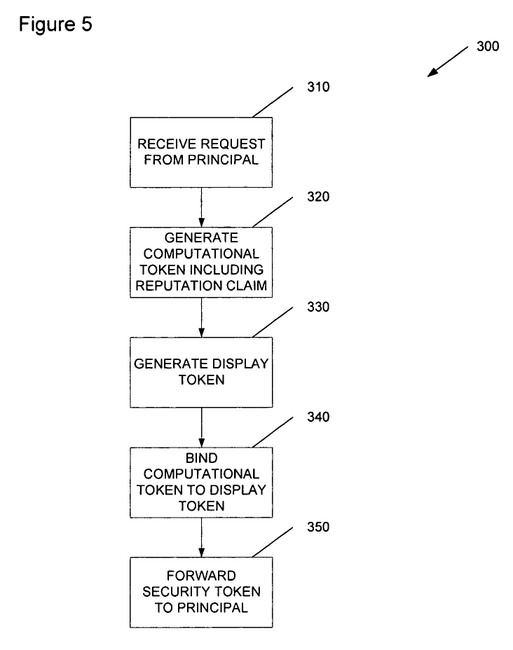

Referring now to FIG. 5, an example method 300 for a claims authority to generate a security token including a reputation claim is shown. Assuming the same example as that described in method 200, method 300 starts at operation 310, at which the claims authority receives the request from the individual's computer to provide a security token with the individual's credit score. In one example, the claims authority is a security token service of a credit reporting agency. Next, at operations 320 and 330, the security token service of the credit reporting agency generates the computational and display tokens including the credit score. Control is then passed to operation 340, at which the display token is bound to the computational token to form the security token. Next, at operation 350, the security token service of the credit agency forwards the security token to the individual.

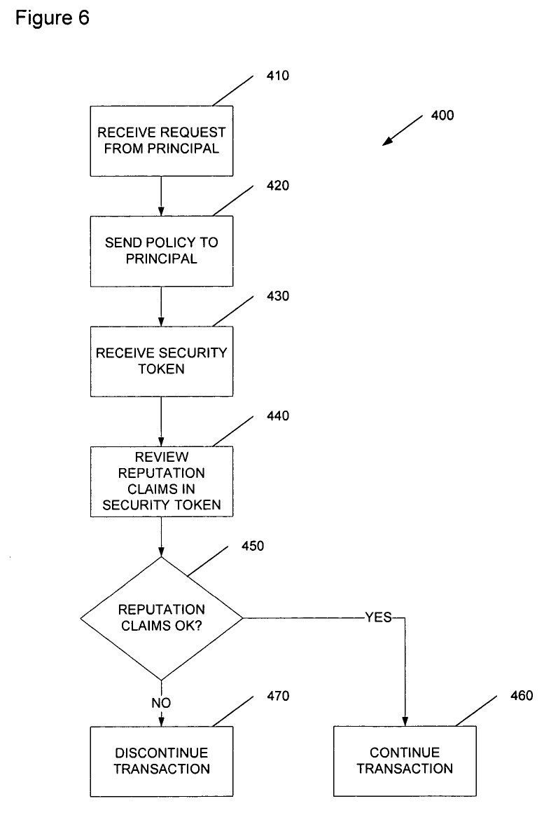

Referring now to FIG. 6, an example method 400 for a relying party to use reputation information is shown. Starting at operation 410, the relying party bank receives a request for a home mortgage from the individual. Next, at operation 420, the bank forwards the bank's security policy requiring a credit score to the individual. Next, at operation 430, the bank receives the security token from the individual (or directly from the security token service of the credit reporting agency). Control is then passed to operation 440, at which the bank examines the credit score in the security token. Next, at operation 450, the bank determines whether or not the credit score meets the bank's criteria. If the credit score is sufficient, control is passed to operation 460, and the individual is approved for the requested mortgage. Alternatively, if the credit score at operation 450 is insufficient, control is passed to operation 470, and the individual is not approved for the requested mortgage.

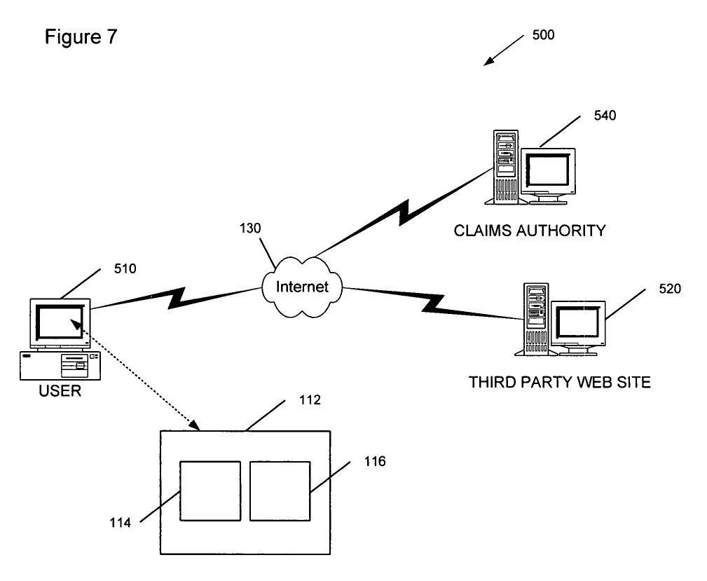

Referring now to FIG. 7, another embodiment of a system 500 is shown including a user 510, an online service such as third party web site 520, and a claims authority 540. In the example shown, user 510 can access third party web site 520 through the Internet 130 to request goods, services, or other information from web site 520.

Prior to or in conjunction with accessing third party web site 520, user 510 can also access claims authority 540 to request reputation information about third party web site 520 from claims authority 540. In example embodiments, user 510 can identify the third party web site 520 in the request for reputation information sent to claims authority 540 by the domain name of the third party web site 520, the public key associated with the web site, and/or by the name of the company associated with the web site. Other types of identification can be used.

In example embodiments, claims authority 540 is a claims authority that includes reputation information about one or more third parties. Claims authority 540 can generate the reputation information, or claims authority 540 can aggregate reputation information from one or more third party sources. In example embodiments, claims authority 540 is in a trusted relationship with user 510. User 510 can use the reputation information associated with third party 520 from claims authority 540, for example, to decide whether or not to transact with third party 520.

In some embodiments, claims authority 540 sends the reputation information to user 510 in a security token signed by claims authority 540. The security token can, but need not, include a display token.

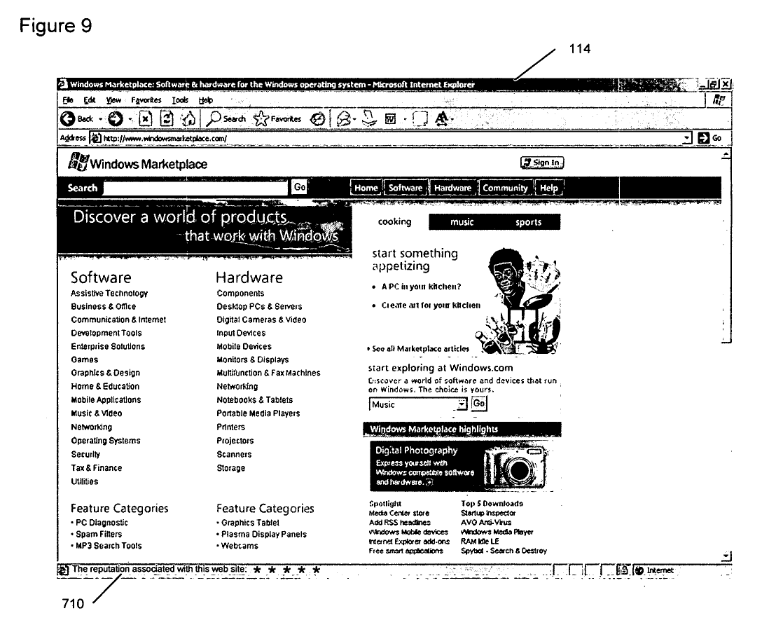

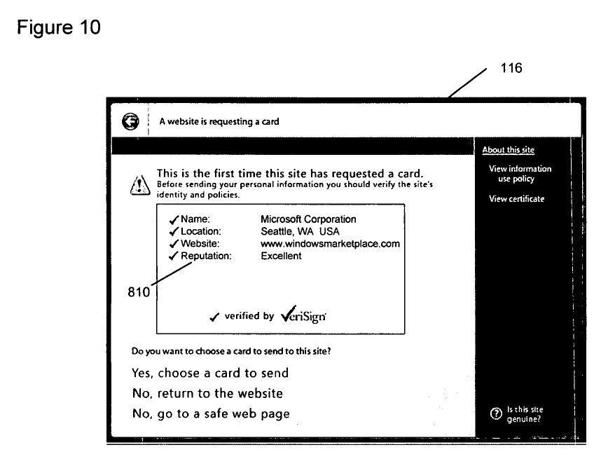

In some embodiments, the reputation information is presented to the user in the form of a visual indicator (e.g., text, color, and/or scaled markers such as stars or a bar that increases in number or size with superior reputation). See FIGS. 9 and 10 described below. Other indications, such as a numerical value or audible indicators can be used.

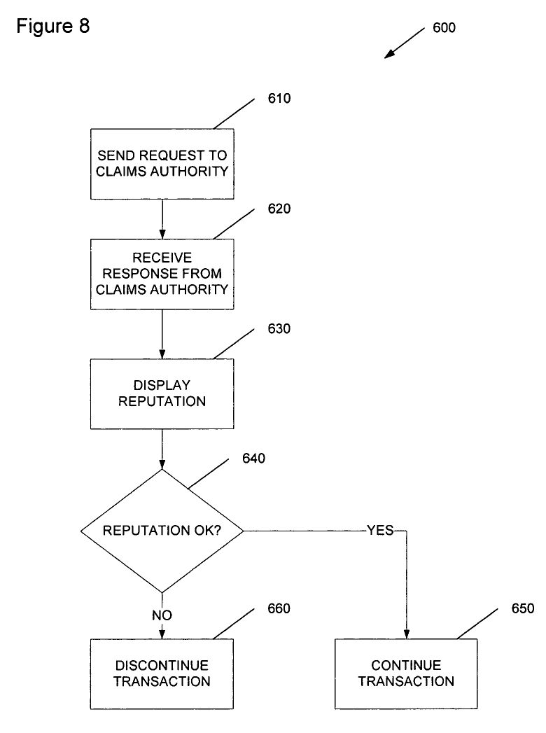

Referring now to FIG. 8, an example method 600 for a user to request reputation information about a web site from a claims authority is shown. At operation 610, the user sends a request for reputation information about a third party to a claims authority. In example embodiments, the request can be automatically generated when the user visits the web site. In another example, the request can be manually initiated by the user.

In one embodiment, the user is an individual shopping online to purchase a camera, and the third party operates a web site that offers cameras for sale online. The user's browser 114 is programmed to automatically seek reputation information about a web site when the web site, such as the third party web site, is loaded in browser 114.

Next, at operation 620, the individual receives the response from the claims authority about the third party web site. For example, the user receives a security token with reputation information about the third party web site. Next, at operation 630, the reputation information is displayed for the user. Next, at operation 640, the user decides whether or not the reputation is sufficient to continue transacting with the third party. For example, if the user is contemplating a financial transaction with the web site such as purchasing a camera, the user may require a certain reputation that is greater than if the user simply wants to obtain information from the web site such as news.

If the user decides that the reputation information is sufficient, control is passed to operation 650, and the user begins or continues to transact with the third party web site to purchase the camera. Alternatively, if the reputation information is insufficient in operation 640, control is passed to operation 660, and the user discontinues or otherwise does not transact with the third party web site to purchase the camera.

Referring again to FIG. 7, when the user receives the reputation information from claims authority 540, the reputation information can be displayed in browser 114 or separate interface 116 on display 112. The reputation information can be displayed to the user in the form of a value (e.g., a numeric value) or a scale (e.g., graded “A”-“F”). From example, the reputation information can be displayed to the user in a color-coded and/or a “star” scale. In some embodiments, the reputation information is provided to the user in the form of an image that can be displayed to the user. For example, in one embodiment, the reputation information is provided by the claims authority in the form of an image (e.g., a bitmap or JPEG) with markers (e.g., stars) and/or colors (e.g., red, yellow, green) to indicate the magnitude of the reputation of the third party. The image can be displayed to the user on display 112.

For example, referring now to FIG. 9, in one embodiment, browser 114 is programmed to provide reputation information from claims authority 540 in a status bar 710 of browser 114. In the illustrated embodiment, reputation information in status bar 710 indicates that the web site shown in browser 114 has a “five star” reputation.

Referring now to FIG. 10, in an alternative embodiment, reputation information is shown in separate graphical user interface 116. For example, user interface 116 includes reputation information 810 (e.g., “Excellent”). Other configurations are possible.

There are one or more advantages associated with the systems and methods described herein that provide reputation information as part of identity systems. For example, utilizing reputation information as part of an identity system can allow the reputation information to be shared and aggregated in a standardized format that can be more easily consumed. Relying parties can utilize reputation information from trusted third parties when deciding whether or not to transact with a principal, thereby increasing the relying party's confidence in the transaction. In addition, users can use reputation information about third parties when deciding whether or not to transact with the third parties, thereby increasing the user's confidence in the transaction.

The various embodiments described above are provided by way of illustration only and should not be construed to limiting. Those skilled in the art will readily recognize various modifications and changes that may be made to the embodiments described above without departing from the true spirit and scope of the disclosure or the following claims.

What is claimed is:

1. A system for providing reputation information, the system comprising a relying party programmed to receive a security token including a claim with reputation information associated with a party, and the relying party being further programmed to utilize the reputation information when deciding whether to transact with the party.

2. The system of claim 1, wherein the reputation information is information about a perceived quality or character of the party as measured by one or more individuals or organizations.

3. The system of claim 1, wherein the security token includes a computational token and a display token, the computational token including the claim with the reputation information associated with the party, and the display token including display information about the claim with the reputation information.

4. The system of claim 1, further comprising a security policy of the relying party that defines the reputation information required by the relying party, wherein the relying party is programmed to forward the security policy to the party.

5. A method of providing reputation information, the method comprising:
receiving a request for information from a party;
requiring the party to provide reputation information;
receiving the reputation information in a claim of a security token; and
using the reputation information to decide whether to transact with the party.

6. The method of claim 5, wherein the reputation information is information about a perceived quality or character of the party as measured by one or more individuals or organizations.

7. The method of claim 5, wherein the security token includes a computational token and a display token, the computational token including the claim with the reputation information associated with the party, and the display token including display information about the claim with the reputation information.

8. The method of claim 5, wherein requiring the party to provide the reputation information further comprises issuing a security policy that defines the reputation information required by the relying party.

9. A computer-readable medium having comuputer-executable instructions for performing the steps recited in claim 5.

10. A method of providing reputation information, the method comprising:
requesting reputation information associated with an online service from a claims authority;
receiving the reputation information in a claim of a security token; and
using the reputation information to decide whether to transact with the online service.

11. The method of claim 10, wherein the reputation information is information about a perceived quality or character of a party associated with the online service as measured by one or more individuals or organizations.

12. The method of claim 10, further comprising displaying the reputation information.

13. The method of claim 12, wherein displaying the reputation information further comprises displaying the reputation information in a browser.

14. The method of claim 12, wherein requesting the reputation information further comprises automatically requesting the reputation information when the online service is accessed.

15. A computer-readable medium having computer-executable instructions for performing the steps recited in claim 11.
